(19) United States
(12) Patent Application Publication
(10) Pub. No.: US 2008/0107039 A1
(43) Pub. Date: May 8, 2008

(54) Method and Apparatus for Estimating Dominance Norms of a Plurality of Signals

(76) Inventors: Marios Hadjieleftheriou, Madison, NJ (US); Stilian A. Stoev, Ann Arbor, MI (US); George Kollios, Cambridge, MA (US); Murad S. Taqqu, Newton, MA (US)

Correspondence Address: AT&T CORP., ROOM 2A207, ONE AT&T WAY, BEDMINSTER, NJ, 07921, US

(21) Appl. No.: 11/556,075

(22) Filed: Nov. 2, 2006

(51) Int. Cl. H04J 1/16

(52) U.S. Cl. 370/252; 370/235

(57) ABSTRACT

A method and apparatus for estimating dominance norms of a plurality of signals transmitted over networks are disclosed. For example, the present invention discloses a method and apparatus for estimating dominance norms of a plurality of signals using Max-stable distributions.

The present invention relates generally to communication networks and, more particularly, to a method and apparatus for estimating norms on the dominant signal of a plurality of signals (i.e., dominance norms) transmitted over networks such as the telecommunications network, e.g., packet networks.

### BACKGROUND OF THE INVENTION

Much of today's important business and consumer applications rely on communications infrastructures such as the Internet, telecommunications network, etc. Network service providers need to be able to estimate various statistics on data being transmitted over their network. For example, network monitoring systems need to determine network utilization rates, variations over time, etc. Current methods that estimate max-dominance norm (i.e., the F₁-norm of the dominant signal) are not extendable for computing more general statistics (F_{α}-norm, αεR₊). For example, if known, F₂-norm may be used to estimate the energy of a signal. However, existing methods for estimating dominance norms do not extend to α>1.

Therefore, there is a need for a method that provides estimates for all dominance norms of a plurality of signals.

### SUMMARY OF THE INVENTION

In one embodiment, the present invention discloses a method and apparatus for estimating dominance norms of a plurality of signals using Max-stable distributions. For example, the present method receives a request to estimate the F_{α}-norm of the dominant signal of a plurality of data streams (e.g., based on source IP addresses). The method then determines the number of independent realizations of atomic sketches required, e.g., based on error bounds or availability of resources (such as memory). The method then creates a set of variables for storing the atomic sketches of the Max-stable sketch, one variable for each independent realization. The number of units of data, e.g., bytes, transmitted by the data streams is retrieved. The method generates independent α-Fréchet random variables, one variable for each atomic sketch. Each atomic sketch is then updated by the maximum of the value already present in the atomic sketch variable and the product of the corresponding α-Fréchet random variable that has been generated and the number of bytes transmitted by the data stream. The estimate of the F_{α}-norm is evaluated using all atomic sketches.

### BRIEF DESCRIPTION OF THE DRAWINGS

The teaching of the present invention can be readily understood by considering the following detailed description in conjunction with the accompanying drawings, in which:

FIG. 1 illustrates an exemplary network related to the current invention;

FIG. 2 illustrates an exemplary network with traffic monitoring;

FIG. 3 illustrates a flowchart of a method for estimating dominance norms of a plurality of signals; and

FIG. 4 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present invention broadly discloses a method and apparatus for estimating dominance norms of a plurality of signals in networks such as telecommunications networks, e.g., packet networks. Although the present invention is discussed below in the context of packet networks, the present invention is not so limited. Namely, the present invention can be applied for other networks with network monitoring such as cellular networks, Time Division Multiplexed (TDM) networks, and the like.

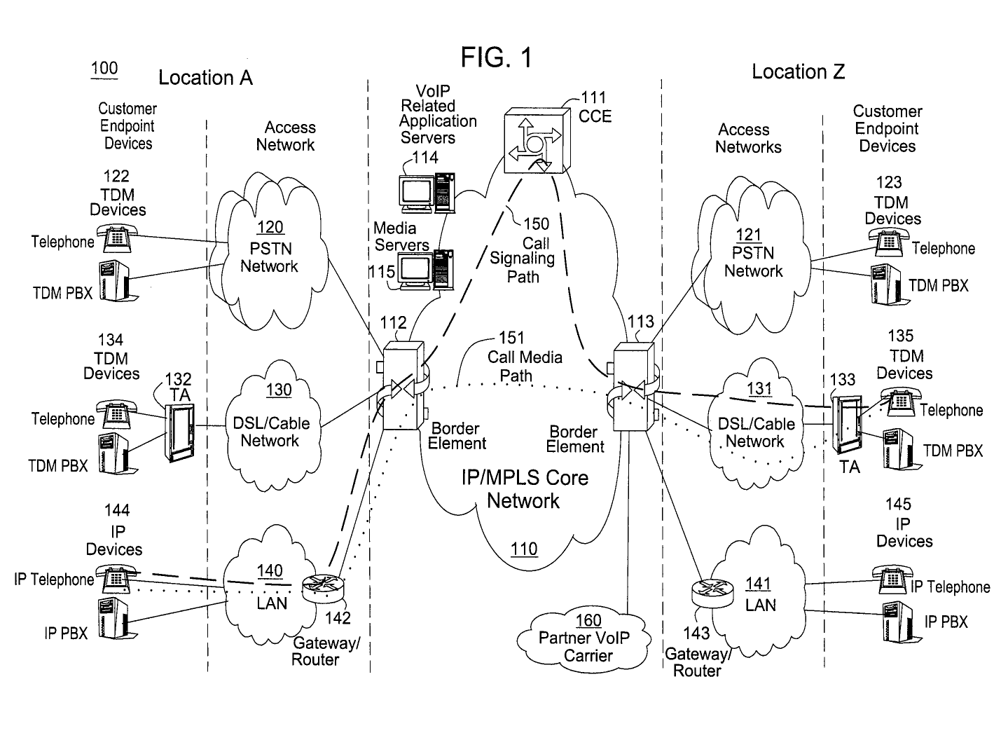

To better understand the present invention, FIG. 1 illustrates an exemplary network 100, e.g., a packet network such as a Voice over Internet Protocol (VoIP) network related to the present invention. Exemplary packet networks include Internet protocol (IP) networks, Asynchronous Transfer Mode (ATM) networks, frame-relay networks, and the like. An IP network is broadly defined as a network that uses Internet Protocol to exchange data packets. Thus, a VoIP network or a Service over Internet Protocol (SOIP) network is considered an IP network.

In one embodiment, the VoIP network may comprise various types of customer endpoint devices connected via various types of access networks to a carrier (a service provider) VoIP core infrastructure over an Internet Protocol/Multi-Protocol Label Switching (IP/MPLS) based core backbone network. Broadly defined, a VoIP network is a network that is capable of carrying voice signals as packetized data over an IP network. The present invention is described below in the context of an illustrative VoIP network. Thus, the present invention should not be interpreted as limited by this particular illustrative architecture.

The customer endpoint devices can be either Time Division Multiplexing (TDM) based or IP based. TDM based customer endpoint devices 122, 123, 134, and 135 typically comprise of TDM phones or Private Branch Exchange (PBX). IP based customer endpoint devices 144 and 145 typically comprise IP phones or IP PBX. The Terminal Adaptors (TA) 132 and 133 are used to provide necessary inter-working functions between TDM customer endpoint devices, such as analog phones, and packet based access network technologies, such as Digital Subscriber Loop (DSL) or Cable broadband access networks. TDM based customer endpoint devices access VoIP services by using either a Public Switched Telephone Network (PSTN) 120, 121 or a broadband access network 130, 131 via a TA 132 or 133. IP based customer endpoint devices access VoIP services by using a Local Area Network (LAN) 140 and 141 with a VoIP gateway or router 142 and 143, respectively.

The access networks can be either TDM or packet based. A TDM PSTN 120 or 121 is used to support TDM customer endpoint devices connected via traditional phone lines. A packet based access network, such as Frame Relay, ATM, Ethernet or IP, is used to support IP based customer endpoint devices via a customer LAN, e.g., 140 with a VoIP gateway and/or router 142. A packet based access network 130 or 131, such as DSL or Cable, when used together with a TA 132 or 133, is used to support TDM based customer endpoint devices.

The core VoIP infrastructure comprises of several key VoIP components, such as the Border Elements (BEs) 112 and 113, the Call Control Element (CCE) 111, VoIP related Application Servers (AS) 114, and Media Server (MS) 115. The BE resides at the edge of the VoIP core infrastructure and interfaces with customers endpoints over various types of access networks. A BE is typically implemented as a Media Gateway and performs signaling, media control, security, and call admission control and related functions. The CCE resides within the VoIP infrastructure and is connected to the BEs using the Session Initiation Protocol (SIP) over the underlying IP/MPLS based core backbone network 110. The CCE is typically implemented as a Media Gateway Controller or a softswitch and performs network wide call control related functions as well as interacts with the appropriate VoIP service related servers when necessary. The CCE functions as a SIP back-to-back user agent and is a signaling endpoint for all call legs between all BEs and the CCE. The CCE may need to interact with various VoIP related Application Servers (AS) in order to complete a call that requires certain service specific features, e.g. translation of an E.164 voice network address into an IP address and so on. For calls that originate or terminate in a different carrier, they can be handled through the PSTN 120 and 121 or the Partner IP Carrier 160 interconnections. A customer in location A using any endpoint device type with its associated access network type can communicate with another customer in location Z using any endpoint device type with its associated network type.

The above IP network is described only to provide an illustrative environment in which data is transmitted on communication networks. Network service providers need to be able to estimate various statistics on data being transmitted over their network. For example, network service providers may utilize monitoring systems to determine network utilization rates, packet loss statistics, variations of utilization over time, etc. Existing methods that estimate dominance norms are useable only for determining max-dominance norm (F₁-norm). The max-dominance norm is used to determine the maximum utilization assuming coordinated data transmission among all sources. In other words, max-dominance norm is a measure that reflects the maximum possible network utilization which would occur if the transmission from different sources, e.g., source IP addresses, were coordinated. This scenario provides the estimate for one condition (worst case utilization) alone. Proper network design and optimized usage of resources relies on various statistics that may be determined based on other norms. For example, the F₂-norm may be used to estimate the energy of a signal. Therefore, there is a need for a method that may be used to estimate all dominance norms (F_{α}-norm, αεR₊).

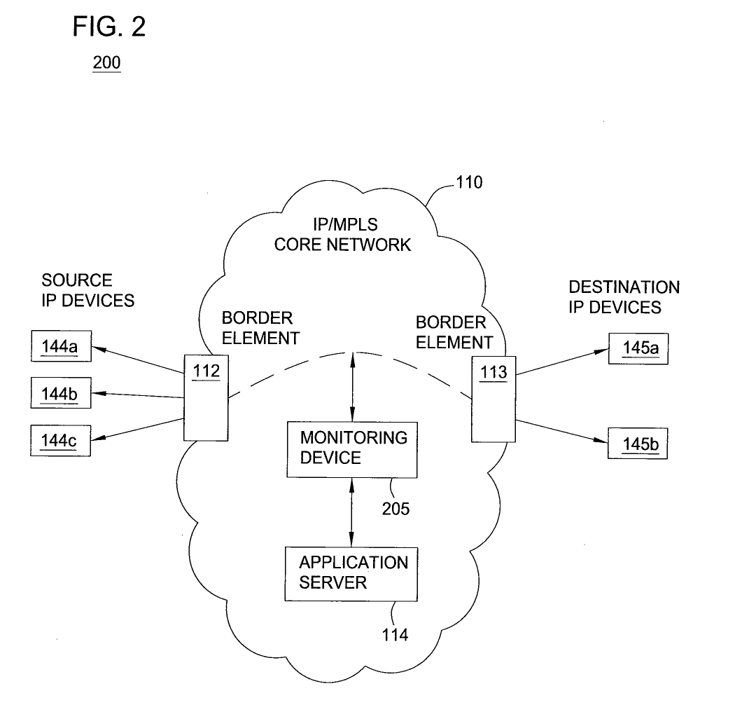

FIG. 2 illustrates an exemplary network 200 with traffic monitoring. For example, IP devices (e.g., source IP endpoint devices) 144a, 144b and 144c access IP/MPLS core network 110 via a border element 112. IP devices 145a and 145b access IP/MPLS core network 110 via a border element 113. Packets transmitted by IP devices 144a-144c towards IP devices 145a and 145b traverse the IP/MPLS core network 110 from border element 112 to border element 113. The network service provider may utilize a monitoring device 205 located in the core network 110 to monitor signals (e.g., data streams) through the network. The network service provider may also utilize an application server 114 for statistical analysis of signals through the network. The above network may be represented for formal analysis as described below.

First, let fₛ(i) represent the total number of bytes transmitted by IP i within interval s, where the domain of items i corresponds to source IP addresses and the different signals s correspond to disjoint measurement intervals. The signal values are observed as streams of tuples (i,fₛ(i)) arriving in arbitrary order in i and s. Note that s may not be made known explicitly to the algorithm. For multiple data streams fₛ: {1, . . . ,N}→[0,M] 1≦s≦S, with different distributions where every signal is defined over a very large domain [N] and maximum number of kilobytes M, storing the data or processing it in real time is not feasible. Each signal fₛ may then be viewed as a set of items (i,fₛ(i)),iε[N], where each i appears only once per signal fₛ.

The dominant signal is defined as fₘₐₓ={(i, maxₛ fₛ(i),∀i)}. A variety of statistical measures may be computed over the dominant signal. For example, the max-dominance norm (F₁-norm) that refers to the maximum possible network utilization that occurs if transmission from all source IP addresses were coordinated may be computed as

$${\sum }_{i} {max}_{s} {f}_{s} ( i ) .$$

### In another example the energy of the signal may be computed from the F₂-norm defined as

$${( {\sum }_{i} {max}_{s} {{f}_{s} ( i )}^{2} )}^{1 / 2} .$$

### For the above network in FIG. 2 the max operation over a large set of input signals is a measure for computing “worst case influence.”

The present invention provides a method and apparatus for estimating dominance norms of a plurality of signals in networks using Max-stable distributions for any αεR₊, within ε error and probability 1−δ using O(1/ε² ln 1/δ N/δ M) space. In order to clearly illustrate the present invention, the following mathematical concepts and terminologies will first be provided:

Max-stable distribution;

α-max-stable sketch (max-stable sketch); and

Standard α-Fréchet distribution.

A random variable z is said to be max-stable if, for any a,b>0, there exist c>0 and dεR such that max{aZ′,bZ″} [symbol] cZ+d, where z′ and z″ are independent copies of z, and [symbol] means equal in distribution.

The α-max-stable sketch of a non-negative signal is defined as

$${E}_{j} ( f ) = {max}_{1 \leq i \leq N} f ( i ) {Z}_{j} ( i ) , 1 \leq j \leq K ,$$

where the random variables f: {1, . . . ,N}→[0,M] Zⱼ(i) are max-stable independent standard α-Fréchet as defined below.

A random variable z is said to be standard α-Fréchet if

$$ℙ \{ {Z}_{j} ( i ) \leq x \} = {Φ}_{α} ( x ) \text{:} = \{ \begin{matrix}{e}^{- {x}^{- α}} , & x > 0 \\ 0 , & x \leq 0 ,\end{matrix} for arbitrary α > 0.$$

The above equation max{aZ′,bZ″} [symbol] cZ+d holds for any independent standard α-Fréchet random variable z, z′, and z″. First, let Z, Z(1), . . . ,Z(n) be Independent Identically Distributed (IID) standard α-Fréchet random variables and let f(i)≧0. Then, for any x>0:

$$\begin{matrix}P \{ {max}_{1 \leq i \leq N} f ( i ) Z ( i ) \leq x \} = {\prod }_{1 \leq i \leq N} P \{ Z ( i ) \leq x / f ( i ) \} \\ = exp \{ - {\sum }_{i = 1}^{N} {f ( i )}^{α} {x}^{- α} \}\end{matrix}$$

and thus the weighted maxima is

$$ξ \text{:} = {max}_{1 \leq i \leq N} f ( i ) Z ( i ) {=}^{d} {( {\sum }_{i} {f ( i )}^{α} )}^{1 / α} Z = {‖ f ‖}_{α} Z ,$$

where [symbol] means equal in distribution; and
∥f∥_{α} is the F_{α}-norm of f. That is, the weighted maxima ξ is an α-Fréchet variable with scale coefficient equal to ∥f∥_{α}.

Hence, the max-stability of the Zⱼ(i)'s implies that

Eⱼ(f) [symbol] ∥f∥_{α}Z₁(1),1≦j≦K.

Using P{Z≦med(Z)}=½ for the median of the α-Fréchet variable z, and solving exp{−σ^{α}med(Z)^{-α}}=½ for the median, where a represents the scale coefficient, the median may be expressed as:

$$med ( Z ) = \frac{σ}{{( ln 2 )}^{1 / α}} .$$

Letting an approximation of the F_{α}-norm be represented by L_{α}(f), then for K independent realizations of the weighted maxima:

L_{α}(f):=(ln2)^{1/α}med{Eⱼ(f),1≦j≦K}.

For error εε(0,1) and probability of failures δ>0 (i.e., estimate within ε error with probability 1−δ):

$$P \{ \vert \frac{{L}_{α} ( f )}{{‖ f ‖}_{α}} - 1 \vert \leq ɛ \} \geq 1 - δ$$

provided that

$$K \geq \frac{C}{{ɛ}^{2}} log ( \frac{1}{δ} ) ,$$

for some c>0.

### The above inequality holds, given that

$$\frac{{L}_{α} ( f )}{{‖ f ‖}_{α}} {=}^{d} {( ln ( 2 ) )}^{1 / α} med \{ {ξ}_{j} , 1 \leq j \leq K \} ,$$

where ξᵢ are independent standard α-Fréchet variables, and observing that the derivative of Φ_{α}⁻¹(y)=(ln(1/y))^{-1/α} at y=½ is bounded.

Hence, L_{α}(f) may be used as an εapproximation of the F_{α}-norm of the signal, for arbitrary α>0. The power of the max-stable sketch lies in the fact that the α-Fréchet variables are simulated easily in practice. In one embodiment, the α-Fréchet variables are simulated using uniformly distributed variables as follows:

Let Uⱼ, jεN be independent uniformly distributed variables in (0,1), then Zⱼ:=Φ_{α}⁻¹(Uⱼ)=(ln(1/Uⱼ))^{-1/α} are independent standard α-Fréchet random variables. For all x>0:

$$\begin{matrix}ℙ \{ {( ln ( 1 / U ) )}^{- 1 / α} \leq x \} = ℙ \{ ln ( 1 / U ) \geq {x}^{- α} \} \\ = ℙ \{ U \leq {e}^{- {x}^{- α}} \} = {e}^{- {x}^{- α}} .\end{matrix}$$

The cost of updating the max-stable sketch is dominated by the need to generate the K α-Fréchet variables corresponding to each atomic sketch of the Max-stable sketch. Every insertion needs to update all variables K comprising the sketch. This operation may become expensive for large sketch sizes, especially in streaming applications where fast insertions are critical.

In one embodiment, the cost of insertions is reduced significantly by partitioning the problem into smaller subsets. In particular, instead of updating all the K variables for every insertion i, the input domain is partitioned into a number of groups G, and a disjoint subset of K/G variables is assigned to every group. The partitioning of the input domain may be performed using any universal hash function. Every group then forms an independent max-stable sketch on a smaller domain using only K/G variables. An example of an algorithm for constructing a faster α-max-stable sketch over a set of signals is shown in Table 1:

TABLE 1
Fast Max-Stable Insertion

| | |
|---|---|
| Input: | A set of K variables, Number of groups G, Item i, Value fₛ(i) for |
| | arbitrary signal s, Hash function h. |
| Code | Initialize Pseudo Random number Generator (PRG) R(i) using i |
| | as the seed. |
| | g = h(i)mod G |
| | for g K/G ≦ c ≦ (g + 1) K/G do |
| | U = draw the next uniform number from R |
| | Z = ln(1/U)^{-1/α} |
| | K_{c} = max (K_{c}, fₛ(i) · Z) |
| Output | K/G α - Fréchet variables |

In one embodiment, the algorithm above reduces the cost of each insertion by a factor G. Now, in order to estimate the F_{α}-norm of each group individually as in the original max stable-sketch, let L₁=L_{α}(f), . . . ,L_{G}=L_{α}(f_{G}) be these estimates, and sum the results as follows:

L_{α}(f):=(L₁^{α}+ . . . +L_{G}^{α})^{1/α}.

Since every item belongs to only one group, the equation above is an estimate of ∥f∥_{α} as described below:

Let, εε(0,1), δ>0, K/G≧C/ε² log (1/δ) and let L₁, . . . ,L_{G} be the individual estimates per group, with |Lᵢ/∥fᵢ∥_{α}−1|≦ε, with probability 1−δ.

### Then:

$$ℙ \{ {( 1 - ɛ )}^{α} \leq \frac{{\sum }_{i ∈ [ G ]} {L}_{i}^{α}}{{\sum }_{i ∈ [ G ]} {‖ {f}_{i} ‖}_{α}^{α}} \leq {( 1 + ɛ )}^{α} \} \geq 1 - G δ .$$

Hence, the fast α-max-stable sketch with G groups provides (1±ε)^{α}-approximate answers with probability 1-Gδ. The upper bound may be proved by observing that Lᵢ≦(1+ε)∥fᵢ∥_{α}. Then, Lᵢ^{α}≦(1+ε)^{α}∥fᵢ∥_{α}^{α}, and by taking the sum

$${\sum }_{i ∈ [ G ]} {L}_{i}^{α} \leq {( 1 + ɛ )}^{α} {\sum }_{i ∈ [ G ]} {‖ {f}_{i} ‖}_{α}^{α} .$$

The lower bound may be shown similarly. The probability of failure may then be computed directly by applying the union bound.

Note that lim_{ε→0}(1±ε)^{α}/(1±ε)=α=constant and also for α=1, the error bound of the fast max-stable sketch is equal to the error bounds of the individual group max-stable sketches. As a result, the fast max-stable sketch has excellent insertion performance, while providing accurate estimates that do not diverge significantly from those of the original sketch.

In one embodiment, the above method is used for approximating distances, and for recovering exactly relatively large components of f with high probability.

For the above example with two signals f,g: {1, . . . ,N}→[0,M], let Eⱼ(f), Eⱼ(g), j=1, . . . ,K be α-max stable sketches of f and g for arbitrary α>0. Note that the max-stable sketches are non-linear and therefore even if f(i)≦g(i), 1≦i≦N, the sketch Eⱼ(g−f) does not equal Eⱼ(g)−Eⱼ(f). However, a distance between the signals f and g other than the norm ∥f−g∥_{α} may be introduced which can be computed by using the sketches Eⱼ(f) and Eⱼ(g).

Consider the functional

$${‖ {f}^{α} - {g}^{α} ‖}_{1} \text{:} = {\sum }_{i} \vert {f ( i )}^{α} - {g ( i )}^{α} \vert .$$

The functional ∥f^{α}−g^{α}∥₁ is a metric on R₊^{N}. Due to the non-linearity of the max-stable sketches, this metric, rather than the norm ∥f−g∥_{α}, is more natural. Suppose for example that we have indicator signals, i.e., f(i)=1_{A}(i) and g(i)=1_{B}(i), for some A, B⊂{1, . . . ,N}. The problem of efficiently estimating the size of the intersection |A∩B| is difficult. Nevertheless, since ∥f^{α}−g^{α}∥₁=|A∩B| (independently of α>0), by estimating this distance well, the size of the intersection may be estimated.

In another example with a change detection or classification application, given a set of signals fₛ(i),i≦s≦S, the invention may be used to determine how the set of signals group or cluster together. For example, if the information available about the signals is their max-sketches, then the S×S distance matrix D=(D_{α}(fₛ,f₁))_{1≦s,1≦S} may be computed. Other clustering and visualization algorithms may be then applied to the matrix D to determine possible associations and similarity patterns between the signals. For example, the class of multidimensional scaling algorithms, generate points xₛ, 1≦s≦S in an r-dimensional space, with pair-wise distances given by D. The goal is to find low-dimensional representations which reveal patterns and structure among the points. These point configurations may be further visualized (automatically or interactively). If the max operation is denoted by ‘ν’, Observe that:

$$\begin{matrix}{‖ {f}^{α} - {g}^{α} ‖}_{1} = {\sum }_{i} ( {f ( i )}^{α} ⋁ {g ( i )}^{α} - {f ( i )}^{α} ) + {\sum }_{i} ( {f ( i )}^{α} ⋁ {g ( i )}^{α} - {g ( i )}^{α} ) \\ = 2 {‖ f ⋁ g ‖}_{α}^{α} - {‖ f ‖}_{α}^{α} - {‖ g ‖}_{α}^{α} .\end{matrix}$$

By the max-linearity of max-stable sketches, the method gets Eⱼ(fνg)=Eⱼ(f)νEⱼ(g). The terms in the last expression may be estimated in terms the estimator L_{α}(f) above. Namely, the method defines:

$${D}_{α} ( f , g ) := 2 {{L}_{α} ( f ⋁ g )}^{α} - {{L}_{α} ( f )}^{α} - {{L}_{α} ( g )}^{α} . \\ For ɛ , η ∈ ( 0 , 1 ) , δ > 0 and {‖ {f}^{α} - {g}^{α} ‖}_{1} \geq η {‖ f ⋁ g ‖}_{α}^{α} , \\ ℙ \{ \vert \frac{{D}_{α} ( f , g )}{{‖ {f}^{α} - {g}^{α} ‖}_{1}} - 1 \vert \leq 𝒪 ( ɛ / η ) \} \geq 1 - 3 δ ,$$

provided that K≧C/ε² log (1/δ) for constant c>0. For the example of the two indicator signals 1_{A}, 1_{B} above, suppose that ∥f^{α}−g^{α}∥₁=|A∩B|≧η∥fνg∥_{α}^{α}=|A∪B|, i.e., |A∩B| is not too small relative to |A∪B|, the above inequality for the probability implies that the current method provides a good estimate of the size of the intersection of the two sets.

In one embodiment, the present method provides estimates of the largest components. For example, point estimates for signal f are first recovered as shown below.

Given an i₀ε{1, . . . ,N}, the method sets

$${g}_{j} ( {i}_{0} ) := \frac{{E}_{j} ( f )}{{Z}_{j} ( {i}_{0} )} , j = 1 , … , K , .$$

### Then, \hat{f}(i₀):=min_{1≦j≦k} gⱼ(i₀).

### For εε(0,1), δ>0 and i₀ε{1, . . . N}, if f(i₀)>ε∥f∥_{α} and K≧1/ε^{α} (1/δ), then P{\hat{f}(i₀)=f(i₀)}≧1−δ. In this equation, α is chosen at sketch creation time according to the norm to be estimated by the sketch.

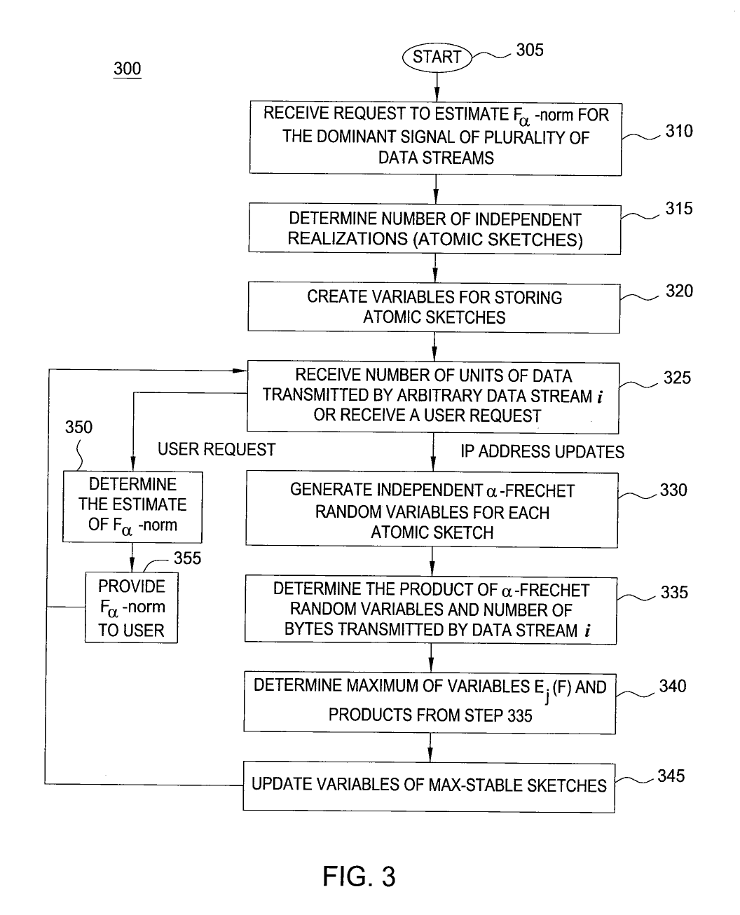

FIG. 3 illustrates a flowchart of a method 300 for estimating the F_{α}-norm of the dominant signal of a plurality of signals (e.g., data streams). For example, a service provider may implement the present invention in an application server, and enable the application server to receive the values of the total number of units of data, e.g., bytes, bits, frames, and the like, transmitted by IP devices with preset measurement intervals. The application server may receive the data for the various IP addresses via a monitoring device. The application server is then capable of servicing requests from users for estimates of the F_{α}-norm of the dominant signal.

Method 300 starts in step 305 and proceeds to step 310. In step 310, method 300 receives a request to start estimating the F_{α}-norm for a range of source IP addresses with ε error and probability of failure of estimate δ.

In step 315, method 300 determines a number of independent realizations K. In one embodiment, the number of realizations is determined from ε and δ. In another embodiment, the number of realizations may be limited by the amount of available storage capacity. In that case, the user may provide the number of realizations as an input parameter.

In step 320, method 300 creates a set of variables for storing the atomic sketches of the Max-stable sketch. For example, K variables may be setup to store atomic sketches Eⱼ(f), for each realization j, 1≦j≦K. The variables are initialized by setting Eⱼ(f)=0 for all j.

In step 325, method 300 asynchronously receives the number of bytes transmitted by IP address i. For example, the number of bytes transmitted may be gathered by a monitoring device and forwarded to the application server used to estimate dominance norms. The data may include the IP address, interval s, etc.

It should be noted that in step 325, method 300 may also receive a user request. If so, method 300 proceeds to step 350.

In step 330, method 300 generates K independent α-Fréchet random variables. For example, K uniform random variables U may be created using a pseudo random number generator. The α-Fréchet random variables may then be generated from α and the uniform random variables U, using Z=(1/U)^{-1/α} for each value of U.

In step 335, method 300 determines the products of the α-Fréchet random variables Z₁(i), . . . ,Z_{K}(i) and number of bytes transmitted. For example, the method determines fₛ(i)Z₁(i), fₛ(i)Z₂(i), . . . , fₛ(i)Z_{K}(i).

In step 340, method 300 determines the maximum of variable Eⱼ(f) and the product fₛ(i)Zⱼ(i). For example, the method determines max (E₁(f), fₛ(i)Z₁(i)), max (E₂(f), fₛ(i)Z₂(i)), . . . , max (E_{K}(f), fₛ(i)Z_{K}(i)).

In step 345, method 300 updates the variables of the Max-stable sketch. In particular, the values in variables Eⱼ(f) are replaced by retaining the maximum value max (Eⱼ(f), fₛ(i)Zⱼ(i)) for 1≦j≦K. Then, method 300 proceeds back to step 325 and waits asynchronously for the next IP address update or user request to produce a norm estimate.

In step 350, method 300 determines the estimate of the F_{α}-norm after a user request is received. In particular, the method evaluates the estimate of the F_{α}-norm, L_{α}(f) as L_{α}(f)=(ln2)^{1/α} med {Eⱼ(f), 1≦j≦K}.

In step 355, method 300 provides estimates of F_{α}-norm to the user and proceeds back to step 325 to receive new user requests or IP address updates.

In one embodiment, the Max-stable sketch may be used to recover large values of the dominant signal exactly, with high probability. In another embodiment, the Max-stable sketch may be used for estimating a distance between two dominant signals in applications such as change detection.

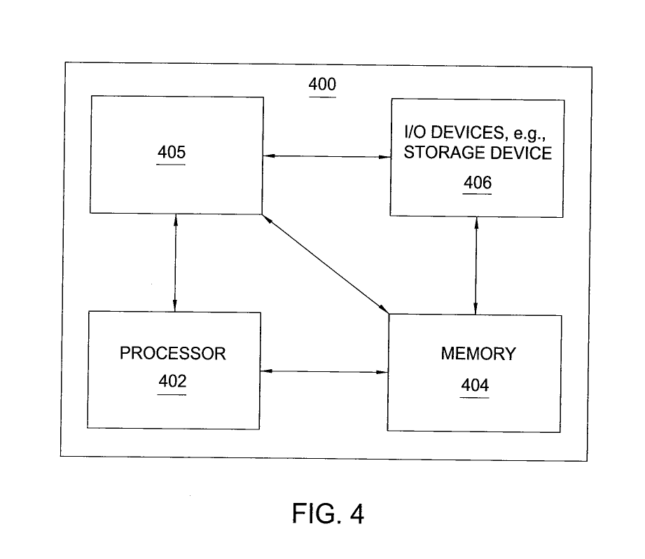

FIG. 4 depicts a high-level block diagram of a general-purpose computer suitable for use in performing the functions described herein. As depicted in FIG. 4, the system 400 comprises a processor element 402 (e.g., a CPU), a memory 404, e.g., random access memory (RAM) and/or read only memory (ROM), a module 405 for estimating F_{α}-norm of signals, and various input/output devices 406 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the present module or into memory 404 and executed by processor 402 to implement the functions as discussed above. As such, the present method 405 for estimating F_{α}-norm of signals (including associated data structures) of the present invention can be stored on a computer readable medium or carrier, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

1. A method for estimating dominance norms (F_{α}-norm) for a plurality of signals, comprising:
receiving a request to estimate a dominance norm (F_{α}-norm) for a plurality of signals;
determining a number of independent realizations;
storing a plurality of variables for each of said independent realizations;
retrieving a number of units of data transmitted by at least one of said plurality of signals;
generating independent α-Fréchet random variables for each of said independent realizations;
updating said variables for each of said independent realizations in accordance with said α-Fréchet random variables and said number of units of data; and
determining an estimate of the dominance norm (F_{α}-norm).

2. The method of claim 1, wherein said plurality of signals comprises a plurality of data streams.

3. The method of claim 2, wherein said plurality of data streams is monitored on a communication network.

4. The method of claim 3, wherein said communication network is a packet network.

5. The method of claim 1, wherein said units of data comprises at least one of: bytes of data, bits of data or frames of data.

6. The method of claim 1, wherein a distance between at least two of said plurality of signals is approximated using said plurality of Max-stable sketches.

7. The method of claim 1, wherein said updating said Max-stable sketches comprises updating said variables for each of said independent realizations in accordance with products of said α-Fréchet random variables and said number of units of data.

8. The method of claim 1, further comprising:
providing said estimate of the dominance norm (F_{α}-norm) as an output to a user.

9. A computer-readable medium having stored thereon a plurality of instructions, the plurality of instructions including instructions which, when executed by a processor, cause the processor to perform the steps of a method for estimating dominance norms (F_{α}-norm) of a plurality of signals, comprising:
receiving a request to estimate a dominance norm (F_{α}-norm) for a plurality of signals;
determining a number of independent realizations;
storing a plurality of variables for each of said independent realizations;
retrieving a number of units of data transmitted by at least one of said plurality of signals;
generating a plurality of independent α-Fréchet random variables for each of said independent realizations;
updating said variables for each of said independent realizations in accordance with said α-Fréchet random variables and said number of units of data; and
determining an estimate of the dominance norm (F_{α}-norm).

10. The computer-readable medium of claim 9, wherein said plurality of signals comprises a plurality of data streams.

11. The computer-readable medium of claim 10, wherein said plurality of data streams is monitored on a communication network.

12. The computer-readable medium of claim 11, wherein said communication network is a packet network.

13. The computer-readable medium of claim 9, wherein said units of data comprises at least one of: bytes of data, bits of data or frames of data.

14. The computer-readable medium of claim 9, wherein a distance between at least two of said plurality of signals is approximated using said plurality of Max-stable sketches.

15. The computer-readable medium of claim 9, wherein said updating said Max-stable sketches comprises updating said variables for each of said independent realizations in accordance with products of said α-Fréchet random variables and said number of units of data.

16. The computer-readable medium of claim 9, further comprising:
providing said estimate of the dominance norm (F_{α}-norm) as an output to a user.

17. An apparatus for estimating dominance norms (F_{α}-norm) of a plurality of signals, comprising:
means for receiving a request to estimate a dominance norm (F_{α}-norm) of a plurality of signals;
means for determining a number of independent realizations;
means for storing a plurality of variables for each of said independent realizations;
means for retrieving a number of units of data transmitted by at least one of said plurality of signals;
of said independent realizations;
means for updating said variables for each of said independent realizations in accordance with said α-Fréchet random variables and said number of units of data; and
means for determining an estimate of the dominance norm (F_{α}-norm).

18. The apparatus of claim 17, wherein said plurality of signals comprises a plurality of data streams.

19. The apparatus of claim 18, wherein said plurality of data streams is monitored on a communication network.

20. The apparatus of claim 17, wherein a distance between at least two of said plurality of signals is approximated using said plurality of Max-stable sketches.
